(19) United States
(12) Patent Application Publication
(10) Pub. No.: US 2010/0264137 A1
(43) Pub. Date: Oct. 21, 2010

(54) Smart hybrid intermodal recyclable shipping container, and method and apparatus therefor

(76) Inventor: Frederick G. Lampe, Granite Falls, NC (US)

Correspondence Address: Frederick G. Lampe, Jr., PO Box 873, 3821 North Main Street, Granite Falls, NC, 28630, US

(21) Appl. No.: 12/386,530

(22) Filed: Apr. 20, 2009

(51) Int. Cl. B65D 88/12; B65D 90/02; B65D 90/54; B29C 39/12; B29C 35/12

(52) U.S. Cl. 220/1.5; 220/651; 220/675; 220/626; 220/826; 264/241; 425/174; 264/404

(57) ABSTRACT

A smart polymer molded hybrid shipping container generally refers to large intermodal shipping container and their manufacture, and more particularly to a recyclable rotationally-molded RF (radio frequency) transparent thermoplastic polymer shell with a removable outer structural fabricated steel load bearing support frame capable of being integrated with an internally mounted geo-location detection system, date transmission communication devices, inner environmental sensors, data storage system, and power storage system. The smart polymer molded hybrid shipping container is designed to be 100% recyclable after useful life with a mechanically fastened exoskeleton steel frame that can be reused in the post manufacturing process. The smart polymer molded hybrid shipping container has a one piece molded shell with load bearing molded in floor system and outer polymer skin that is entirely weather resistant and non-corrosive.

This invention relates generally to large intermodal shipping container and their manufacture, and more particularly to a recyclable rotationally-molded RF (radio frequency) transparent thermoplastic polymer shell with a removable outer structural fabricated steel load bearing support frame capable of being integrated with an internally mounted geo-location detection system, date transmission communication devices, inner environmental sensors, data storage system, and power storage system.

### BACKGROUND OF INVENTION

Large enclosed steel shipping containers are used for a number of purposes, one particular example being so-called intermodal shipping container. Intermodal shipping containers are hollow boxes, fabricated from entirely steel, made in standard sizes and provided with uniform lifting eyes. These containers can be easily lifted, moved, and secured so that they can be shipped by sea, air, or land. Intermodal containers typically manufactured from steel are heavy, expensive, prone to corrosion, and are environmentally difficult to recycle. These steel containers are also difficult to scan with standard x-ray technology from the outside and incapable of accepting RF transmissions into such a container without the use of an exterior antenna. It would be beneficial if such large containers could be made from a substitute material that is RF transparent such as thermoplastic polymers. It would also be beneficial if these containers were capable of integrating geo-location, sensing interior environmental conditions, and transmitting such information in a cost and power efficient manner without the utilization of an exterior antenna. If would also be beneficial if these units could be effectively scanned for any potential bio, chemical, or nuclear hazards prior, during, or after any utilization in a efficient and less costly manner. It would also be beneficial if these container units were environmentally friendly and capable of being easily recycled after useful utilization and product life cycle in a cost effective and efficient manner.

Rotational molding is one known process for producing large hollow plastic products. Rotationally molded products have good strength and durability, and can achieve uniform wall thickness using relatively simple tooling. However, the required heating method is typically done by placing the mold inside a gas or oil fired oven during the molding cycle. This would be prohibitively expensive, be complex for large and rectangular shaped products such as intermodal shipping containers, and would result in uneven heat distribution around the polymer mold. After manufacture of the large thermoplastic polymer shell, a fabricated load bearing steel frame capable of being assembled encapsulating the polymer shell must be attached to the polymer shell to support the upper stack loaded containers.

Accordingly, there is a need for a practical method of molding larger polymer containers and encapsulating the shell into a fabricated steel frame that can be removed for recycling after its useful life while also being RF transparent for data collection and transmission of useful digital and analog information for commercial and national security reasons without the use of exterior antennae.

### BRIEF SUMMARY OF THE INVENTION

The present invention addresses the above-mentioned need by providing a rotationally-molded thermoplastic polymer shipping container with encapsulated load bearing structural exoskeleton steel frame, an independent surface heated mold for producing such polymer-steel hybrid containers, and an apparatus and method for carrying out such molding.

### BRIEF DESCRIPTION OF THE DRAWINGS

The invention may be best understood by references to the following description taken in conjunction with the accompanying drawing figures in which:

FIG. 1 is a side view of the container constructed in accordance with the present invention

FIG. 2 is the top view of the container of FIG. 1;

FIG. 3 is an end view of the container of FIG. 1;

FIG. 4 is a perspective view of a partially assembled container of FIG. 1;

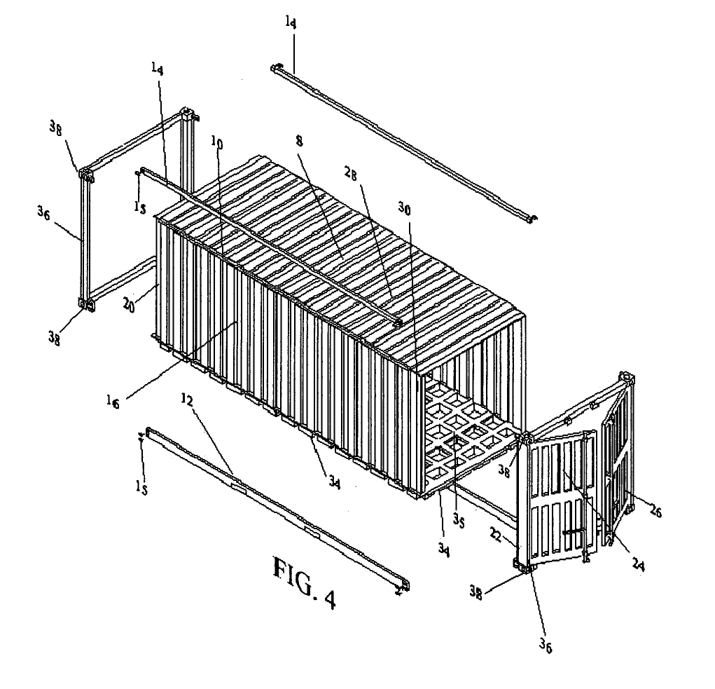

FIG. 5 is a side view of a mold for producing the container of FIG. 1;

FIG. 6 is the top view of the mold of FIG. 5;

FIG. 7 is the end view of the mold of FIG. 5;

FIG. 8 is a perspective view of the mold of FIG. 5;

FIG. 9 is a perspective view of the mold in an open position;

FIG. 10 is a perspective view of the mold apparatus for use with the mold of FIG. 5; and

FIG. 11 is a perspective view of the hybrid polymer steel container with the internally mounted geo-location detection system, date transmission communication devices, inner environmental sensors and data storage system within a molded polymer shell encapsulated in the load bearing steel frame.

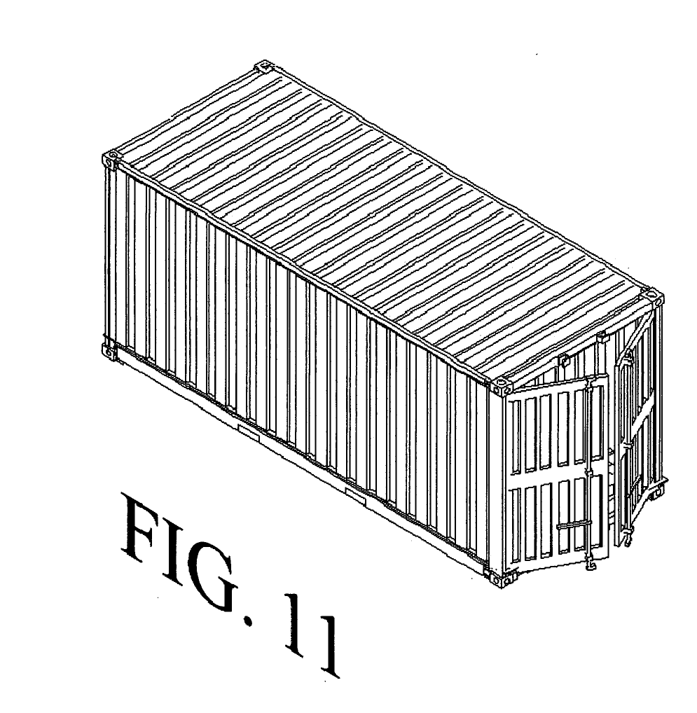

### DETAILED DESCRIPTION OF THE INVENTION

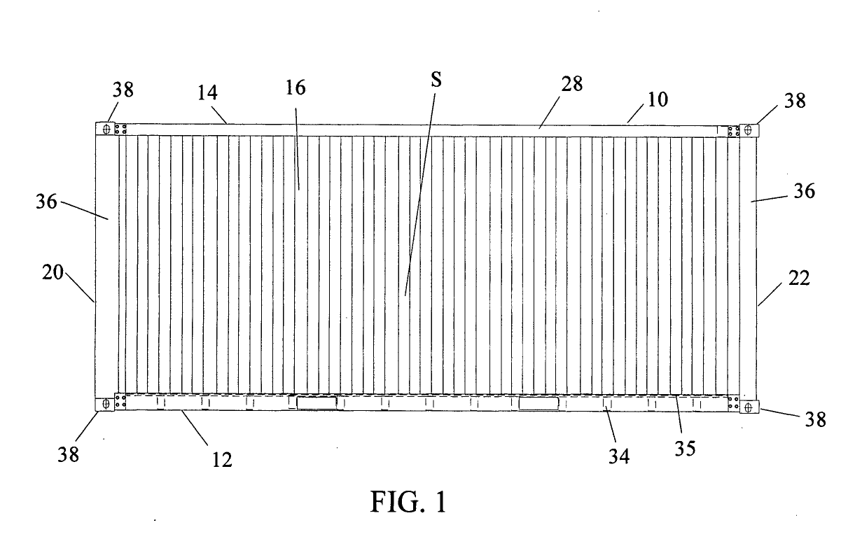

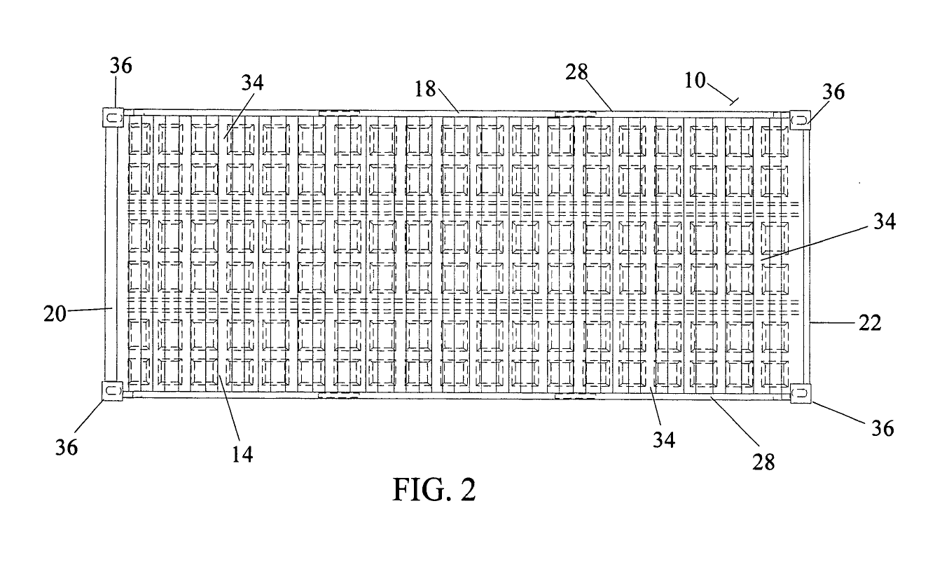

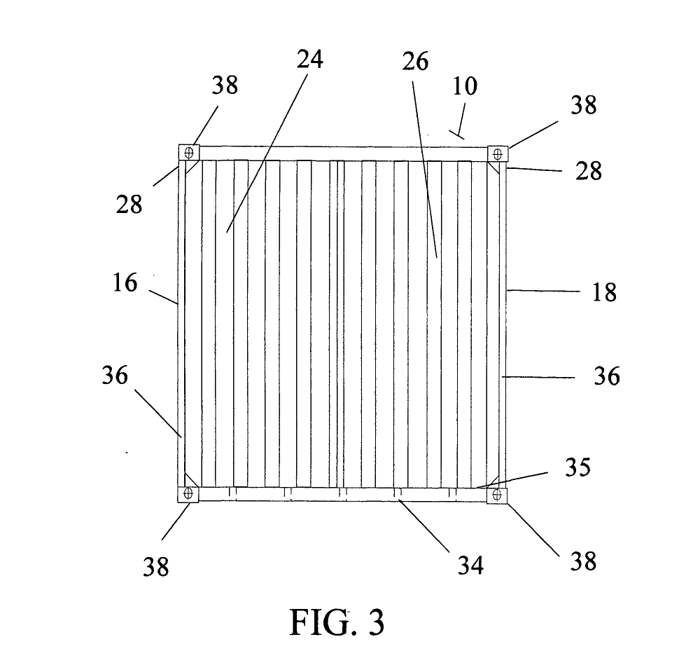

Referring to the drawings wherein identical reference numerals denote same elements throughout the various views, FIGS. 1-3 depict a polymer steel hybrid container 10, the basic components of which are a plywood floor; a sub monocular floor; a roof 14, a pair of spaced-apart side walls 16 and 18, and a pair of spaced-apart end walls 20 and 22; a steel fabricated front frame; a steel fabricated rear frame; top rail; and lower bottom rail. In the illustrated example, the container 10 is designed for use as an intermodal shipping container suitable for being transported by ship, rail, or truck, and has a length between 20 to 48 feet, a height between 8 feet 6 inches and 9 feet 6 inches, and a width of 8 feet. The present invention is equally applicable to other types of containers. At least one of the end walls 20 or 22 is split vertically and hinged to create a pair of doors 24 and 26 which provide access to the interior of the container.

The side walls 16 and 18, end walls 20 and 22, floor 12 and roof 14 of container 10 define a unitary polymer shell “S” which is thermally molded plastic of a high density or linear low density, virgin or recycled polyethylene, which is tough, waterproof, and corrosion resistant, using a rotational molding procedure, described in detail below. If desired the doors 24 and 26 may be made by cutting out one of the end walls 20 and 22 from the shell “S” and replacing it with separate molded pieces. In the illustrated example, the shell “S” is manufactured with a polyethylene resin containing a Ultraviolet inhibitor and color additive to retard aging and fading. The roof 14, side walls 16 and 18, end walls 20 and 22, and monocular floor 12 is molded corrugated panels which in the illustrated example are approximately ⅜ inch thick.

The floor 12 is integrally stiffened with a plurality of longitudinal and lateral molded floor beams 34. Each of the beams are supported can be supported with an external steel channel for fastening plywood floor at joints. A finish floor 35 of 1⅛ inch marine grade plywood or similar approved material is laid over the tops of the floor beams 34 to provide a level load-bearing surface.

The container 10 is encapsulated with a fabricated steel exoskeleton having top and bottom corner castings, corner posts, and horizontal attachment beams. The corner castings include a lifting eye of a known standard type in the industry, which provides purchase for lifting, moving, and securing the container 10. The fabricated steel exoskeleton front and rear frame sections are connected to each other through the top and bottom rail sections. The rail sections are attached to the end frames with removable mechanical fasteners, suitable for load bearing and torque conditions.

The container 10 is integrated with an enclosed electronic sensor package consisting of an internally mounted geo-location detection system, date transmission communication devices, inner environmental sensors and data storage system in the monocular floor system below the plywood deck in a water tight plastic enclosure casing. Internal antennae are installed in the upper roof section and connected with associated electrical wiring.

The container 10 rests upon the fabricated steel exoskeleton and is mechanically attached internally to the front and rear steel frame sections and upper and lower rail sections with suitable mechanical fasteners.

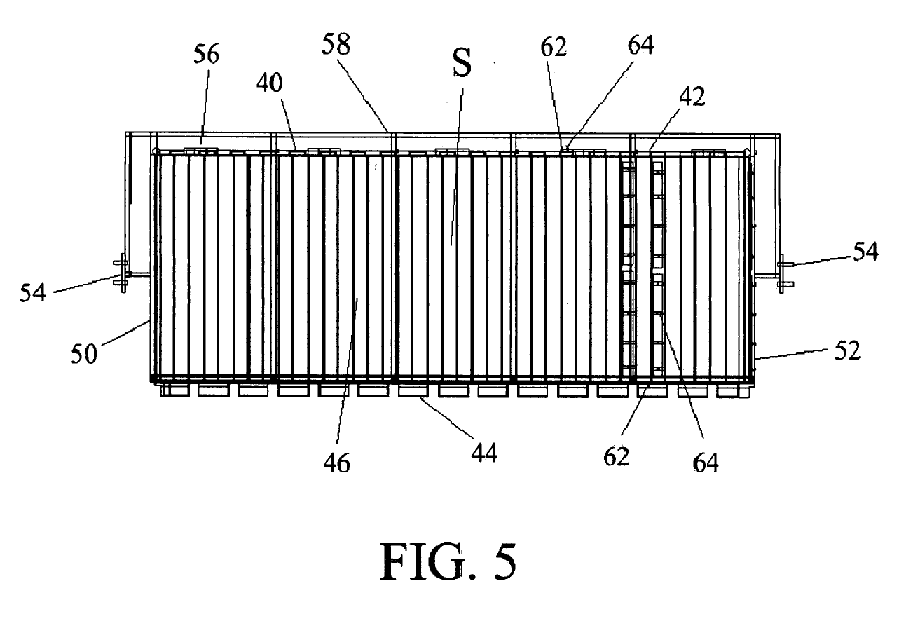

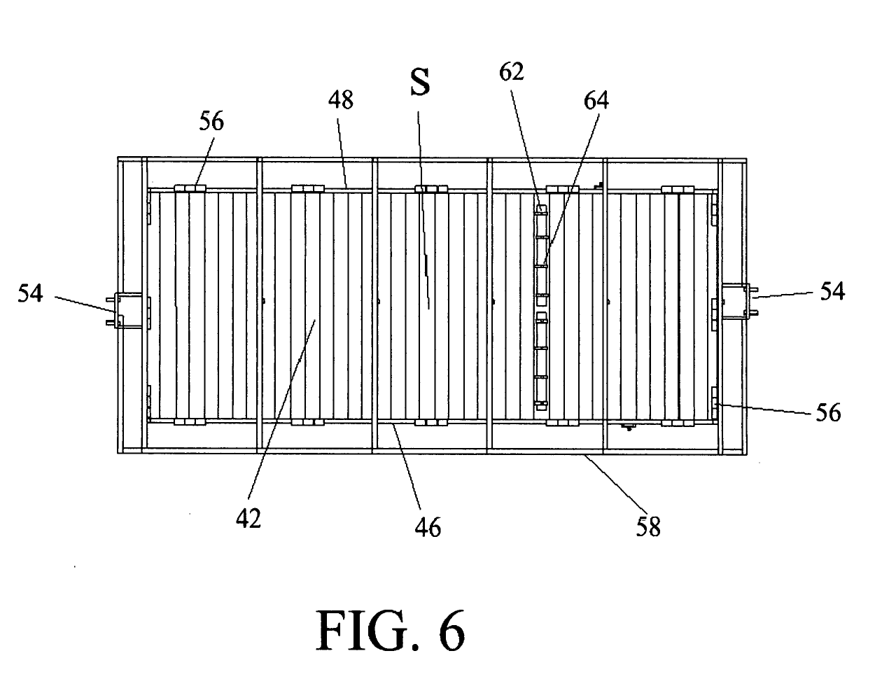

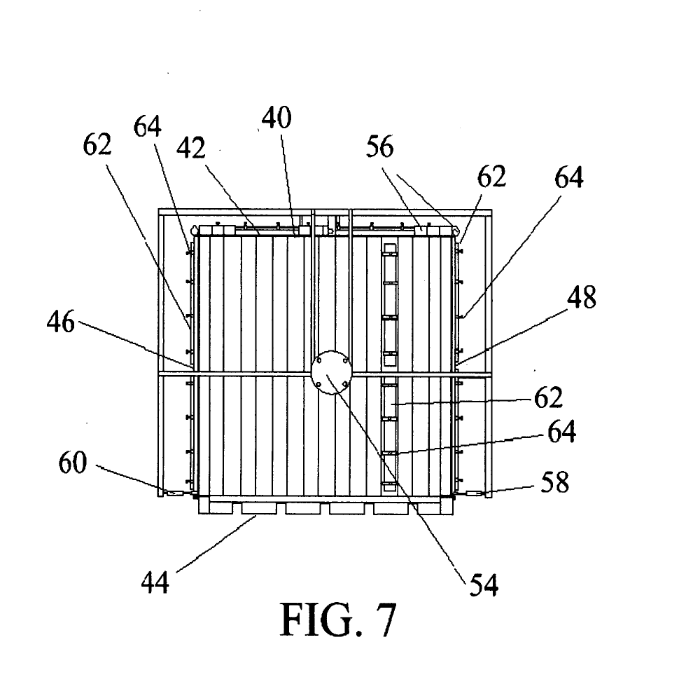

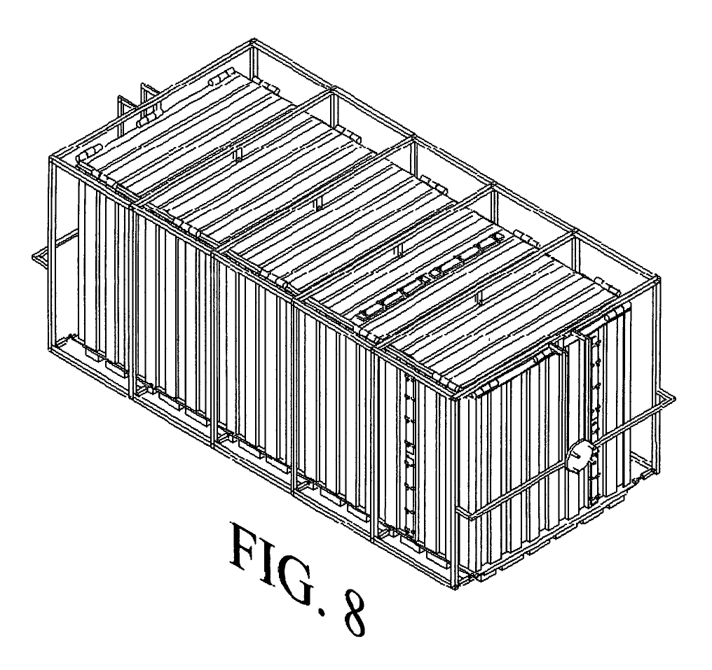

FIGS. 5-9 illustrate a rotational mold for manufacturing the shell “S” of the container 10 described above. The mold 40 is built up from a top panel 42, a bottom panel 44, spaced apart side panels 46 and 48, and spaced-apart end panels 50 and 52, which collectively form a mold space that defines the exterior dimensions of the shell “S” of the container 10. The mold 40 includes mounting pads 54, for example circular discs with protruding studs, on each end thereof for attaching the mold to a rotation inner support assembly (described below). The mold panels are made of a heat resistant, thermally conductive material such as aluminum, and may include stiffening ribs as shown on the outer surfaces. If desired the panels may be coated with a material such as polytetraflouroethylene (PTFE) on the interior surfaces thereof to improve the release characteristics.

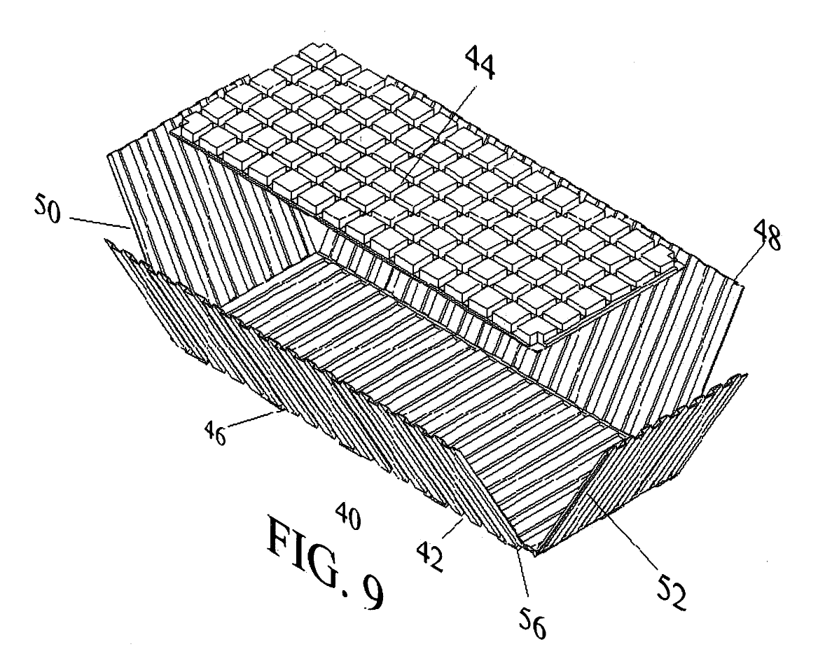

The side panels 46 and 48 are attached to the lower edges to the bottom panel by hinges 56 which allow them to fold down to an open position as shown schematically in FIG. 9. The side panels 46 and 48 are secured in the closed position by suitable clamps, such as the remotely-operated pneumatic side clamps 58 shown in FIGS. 5-7. The bottom panel 44 may be detached from the rest of the mold 40 for charging the mold 40 or removing the finished shell “S” (not shown in FIGS. 5-7). The bottom panel is secured in the closed position by suitable clamps, such as the remotely-operated pneumatic to clamps 60 shown in FIGS. 5-7. The mold 40 is attached to an outer frame 58 allowing thermal expansion on all three axis while also being capable of dual axis rotation.

The mold 40 has a plurality of surface mounted direct contact heaters 62 of suitable wattage attached to the exterior. An example of a suitable heater 62 would be 48 inch long electrical resistance heater rated for 240 volts AC. The size, number, and position of the heaters 62 may be varied to suit a particular application, and they may be arranged into any desired number of heating zones by appropriate arrangement of the electrical supply circuits, powered through rotating Commutator rings (not shown) of sufficient current carrying capability from the main electrical load power source. The heaters are insulated with a suitable fiberglass insulating cloth and covered with aluminum reflective strips to redirect heat back into the mold. The heaters 62 are attached to the panels with clamps 64 which hold the heaters 62 against the panel surface while allowing the heaters to expand and contract separately from the mold 40.

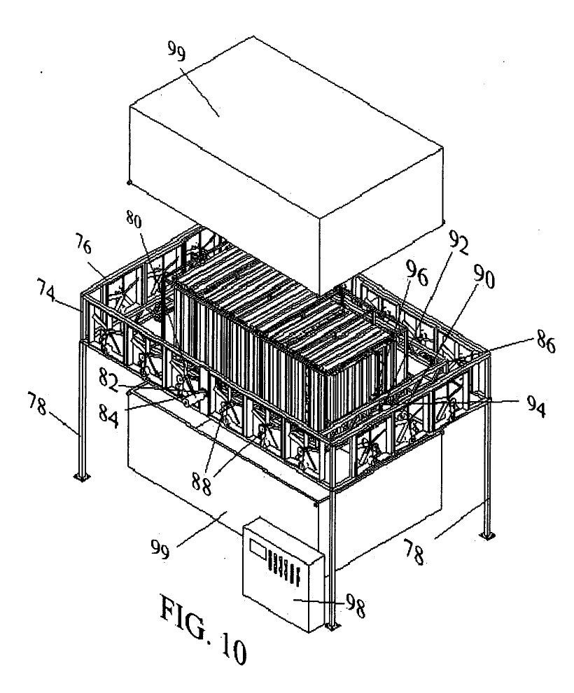

FIG. 10 illustrates a support assembly 74 for holding and manipulating the mold 40. The support assembly 74 comprises an outer frame 76 supported by legs 78. A pair of electrical Commutator rings 80 is mounted to opposite sides of the outer frames 76, aligned along the first or “X” axis. The first rotators 80 may be any kind of actuator capable of rotating the mold 40. In the illustrated example each of the first rotators 80 includes an electric motor 82 connected to a reduction gearbox 84. An inner frame 86 has a plurality of cooling units 88, for example water-cooled fans, and mounted around its periphery. A pair of second rotators 90 is mounted to opposite sides of the inner frame 86, aligned along a second or “Y” axis perpendicular to the “X” axis. The second rotators 90 may be any kind of actuator capable of rotating the mold 40. In the illustrated example each of the second rotators 90 includes an electric motor 92 connected to a reduction gearbox 94, as well as mounting pad 96 for receiving the mating mounting pad 54 on the mold. The support assembly 74 may be mounted over a floor pit or similar structure (not shown) so as to accommodate the swing radius of the inner frame 86 and the mold 40 without excessively long legs 78. The support assembly 74 also includes appropriate means for transferring electrical and/or pneumatic power to the inner frame 86 and the mold 40. For example the first and second rotators 80 and 90 may incorporate slip ring connectors of a known type which allow an electrical current to pass from one rotating part to another. An upper and lower detachable oven 99 is attached to the inner frame to capture and reflect the radiant heat and rotate with the inner frame. This oven is attached with a pneumatic type piston cylinder and movable pin that locks the ovens to the rotating frame through 360 degree rotation.

The molding process and steel frame attachment process proceeds as follows. First, the mold 40 is placed in the inner frame 86 and attached to the mounting pads 96 of the second rotators 90. Electrical and/or pneumatic connections are made between the mold 40 and a control unit 98, which may be a computerized temperature and speed control unit. The side panels 46 and 48 of the mold 40 are closed and locked with side clamps 58. Optionally, the interior of the mold 40 is coated with a suitable release agent. It is then charged with the correct quantity of plastic polymer material, for example polyethylene powder and suitable additives such as ultraviolet inhibitors, color, or foaming materials. The top panel 42 then placed on the mold 40 and secured, for example with top clamps 60. The top and lower insulating oven 99 are then lowered and raised respectively and the oven are attached to the inner rotating frame. The mold 40 is then ready for use. The mold begins to spin on its inners frame assembly 86. The heaters 62 are supplied with electrical current as directed by the control unit 98 to heat the mold 40 to the appropriate temperature. This heat causes the plastic material to soften and melt inside the mold 40. As the material is heated, the control unit 98 signals the first and second rotators 80 and 90 to rotate and tumble the mold 40 in a predetermined manner about the “X” and “Y” axis. This causes the liquefied plastic material to coat the interior of the mold 40. After an appropriate time, the control unit 98 turns the heaters 62 off, raises and lowers the top and lower insulating ovens respectively, and starts the cooing units 88 to cool the mold. When the mold 40 has sufficiently cooled, the rotation is stopped with the top panel facing down. The clamps are removed and the top panel 42 removed. The side clamps 58 are released and the side panels 46 and 48 folded away from the part. This exposes the molded shell “S” so that it may easily be removed from the mold 40 and prepared for subsequent manufacturing steps.

After the polymer shell “S” is removed, it is then coupled and mechanically fastened with the back door end frame, front door frame, top side rail, and lower side rail. The plywood floor is installed and mechanically fastened to the molded floor system. The electronic sensor package consisting of an internally mounted geo-location detection system, date transmission communication devices, inner environmental sensors and data storage system in the monocular floor system is installed below the plywood deck in a water tight plastic enclosure casing. Internal antennas are installed in the upper roof section and connected with associated electrical wiring. The complete unit is inspected and ready for shipment.

The forgoing has described a plastic molded shell encapsulated in to a steel exoskeleton with an electronic sensor package consisting of an internally mounted geo-location detection system, date transmission communication devices, inner environmental sensors and data storage system and a method and apparatus for its production. While specific embodiments of the present invention have been described, it would be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A shipping container, comprising:
a thermoplastic shell defining a closed volume; and
at least one reinforcing beam disposed inside said closed volume and
including an outer envelope, at least part of which is molded integrally with said shell

2. The shipping container of claim 1 wherein an interior of said at least one molded reinforcing beam is molded into floor section, side walls, and roof

3. The shipping container of claim 1 where in the shell includes a floor, a roof, opposed side walls, and opposed end walls of a one piece integral construction

4. The shipping container of claim 1 further comprising at least one door for accessing an interior of said shell

5. A shipping container, comprising:
A thermoplastic shell defining a closed volume; and
An external steel exoskeleton frame comprising a plurality of vertical and horizontal elongated steel beams disposed around such shell to provide structural support of said shell

6. The shipping container of claim 5 wherein said beams are received in recesses defined in an exterior of said shell

7. The shipping container of claim 5 is mechanically fastened from the inside of thermoplastic shell through to the exterior steel exoskeleton frame

8. The shipping container of claim 5 wherein the said external exoskeleton frame includes one corner lug which includes a lifting hole therein.

9. The shipping container of claim 5 further comprising at least one door for accessing an interior of said shell.

10. The shipping container of claim 5 wherein

11. Said shell includes a floor, roof, opposed side walls, and opposed end walls; and
Said floor has at least on floor beam integrally formed therein.

12. The shipping container of claim 11 wherein the front and rear (door) exoskeleton frame sections that are mechanically attached through to each other by top and bottom horizontal beams encapsulating the thermoplastic shell.

13. The shipping container of claim 11 can separate the thermoplastic shell from the steel exoskeleton steel frame by removal of mechanical fasteners for future recycling and reuse.

14. The shipping container of claim 11 can mechanically remove the plywood flooring from the thermoplastic shell for future recycling and reuse.

15. A method of rotational molding a container, comprising:
Providing a mold forming an enclosed volume in a preselected shape of a container, said molding comprising a heat-resistant, thermally conductive material;
providing means for rotating said mold;
charging said mold with a thermoplastic material;
directly heating the exterior of said mold so as to melt thermoplastic material by conduction;
rotating said mold in at least two axes to distribute said thermoplastic material in said mold; and
allowing said thermoplastic material to solidify inside said mold.

16. The method of claim 15 wherein said direct heating is carried out using resistance heaters disposed on said mold.

17. The method of claim 15 wherein said power to resistance heaters is carried through rotating Commutator rings on two axes.

18. The method of claim 15 further comprising actively cooling said mold after mold is charged with said plastic material.

19. A mold for making a container, comprising
A plurality of heat-resistant, thermally conductive panels arranged to form an enclosed volume in a preselected shape of a container; and at least one heater attached to an outer surface of one of said panels

20. The mold of claim 19 wherein at least one heater is an electrical resistance heater.

21. The mold of claim 19 further comprising at least one insert therein; said insert including:
an outer envelope made of a heat-resistant, thermally conductive material, said envelope positioned within said mold to form a selected feature of a container; and a resistance heating element disposed in the interior of the outer envelope along its length.

22. The mold of claim 19 wherein at least some of the panels are pivotally connected as to be able to selectively move from a closed position to an open position.

23. The mold of claim 19 further comprising means for connecting said mold to a moveable frame that could spin within two separate axes simultaneously.

24. A method of using a container, comprising:
providing a container including:
A thermoplastic shell defining a closed compartment of a first volume and an external exoskeleton frame comprising a plurality of elongated vertical and horizontal beams, some that may be welded together disposed around a thermoplastic shell to provide structural support to said shell;
transporting said container to a first location;
removing said external steel exoskeleton steel frame from said thermoplastic shell; and
rendering said thermoplastic shell to a mass of recycled thermoplastic, said mass having a second volume substantially smaller than the first;
capable of integrating said container with an internally mounted geo-location detection system, date transmission communication devices, inner environmental sensors, data storage system, and power storage system.

25. The method of claim 24, further comprising shipping said exoskeleton steel frame, plywood flooring, and substantially reduced volume of said thermoplastic to a second location for further reconstitution and reuse.

26. The claim of 24 wherein the mass is created by mechanically shredding said thermoplastic shell and storing shredded material in a plurality of small pieces in a means suitable for immediate storage and transfer.
